(19) United States
(12) Patent Application Publication
(10) Pub. No.: US 2009/0042541 A1
(43) Pub. Date: Feb. 12, 2009

(54) MOBILE COMMUNICATION DEVICE AND MOBILE COMMUNICATION SYSTEM AND METHOD USING SAME

(75) Inventors: HAI-JUN YI, Shenzhen (CN); SHIH-FANG WONG, Taipei Hsien (TW); LIN-LIN GUO, Shenzhen (CN); DE-HUA TONG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 11/967,089

(22) Filed: Dec. 29, 2007

(30) Foreign Application Priority Data
Aug. 10, 2007 (CN) 200710201338.3

(51) Int. Cl. H04M 1/66

(52) U.S. Cl. 455/411

(57) ABSTRACT

A mobile communication method is used for identifying a subscriber of a mobile communication device. The mobile communication method includes: sampling biometric information of the subscriber; generating an biometric analysis; generating digital signals according to the biometric analysis and an IMEI number; generating RF signals according to the digital signals and transmitting the RF signals; receiving the RF signals and transforming the RF signals to the digital signals; retrieving the biometric analysis and the IMEI number from the digital signals; comparing the biometric analysis and a user biometric profile; selecting a phone number according to the biometric analysis if the biometric analysis and the user biometric profile are the same; and transmitting the phone number to the mobile communication device based on the IMEI number. A mobile communication device and a mobile communication system are also provided.

### BACKGROUND

1. Field of the Invention

The present invention generally relates to mobile communication systems and methods, and more particularly to a mobile communication device for identifying subscribers and a mobile communication system and a mobile communication method using the mobile communication device.

2. Description of Related Art

Mobile communication devices, such as mobile phones, are widely used in mobile communication systems. Subscribers often use mobile communication devices to connect to online banking system to make financial transactions, to connect to the Internet to do online shopping or to receive important Emails. In order to protect the subscribers' accounts, a subscriber identity module (SIM) card is used in a mobile communication device, or a personal identification number (PIN) is used to access the mobile communication system.

However, if the SIM card is stolen or if the PIN is known, individuals other than the subscriber may access the subscriber's account.

Therefore, improvements for a mobile communication device, a mobile communication system, and a mobile communication method are needed in the industry to address the aforementioned deficiency.

### SUMMARY

A mobile communication method is used for identifying a subscriber of a mobile communication device. The mobile communication method includes: sampling biometric information of the subscriber; generating a biometric analysis; generating digital signals according to the biometric analysis and an IMEI number; generating RF signals according to the digital signals and transmitting the RF signals; receiving the RF signals and transforming the RF signals to the digital signals; retrieving the biometric analysis and the IMEI number from the digital signals; comparing the biometric analysis and a user biometric profile; selecting a phone number according to the biometric analysis if the biometric analysis and the user biometric profile are the same; and transmitting the phone number to the mobile communication device based on the IMEI number. A mobile communication device and a mobile communication system are also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram showing a mobile communication system in accordance with an exemplary embodiment;

FIG. 2 is a schematic diagram showing a mobile communication device of the mobile communication system of FIG. 1;

FIG. 3 is a process flow diagram illustrating a mobile communication method in accordance with an exemplary embodiment;

FIG. 4 is a process flow diagram illustrating a closing procedure of the mobile communication device of FIG. 2;

FIGS. 5-10 are schematic diagrams showing graphical user interfaces of the mobile communication device of FIG. 2.

### DETAILED DESCRIPTION OF THE EMBODIMENTS

Reference will now be made to the drawings to describe a preferred embodiment of the present mobile communication device, a preferred embodiment of the present mobile communication system, and a preferred embodiment of the present mobile communication method.

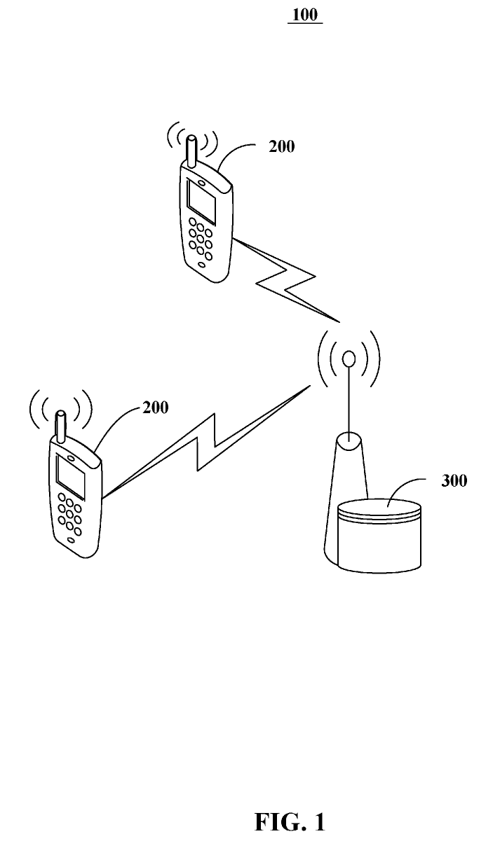

Referring to FIG. 1, a mobile communication system 100 includes a base station 300 and two mobile communication devices 200 in accordance with an exemplary embodiment. The mobile communication devices 200 communicate with each other through the base station 300. The mobile communication devices 200 can identify subscribers for protecting their account from being compromised.

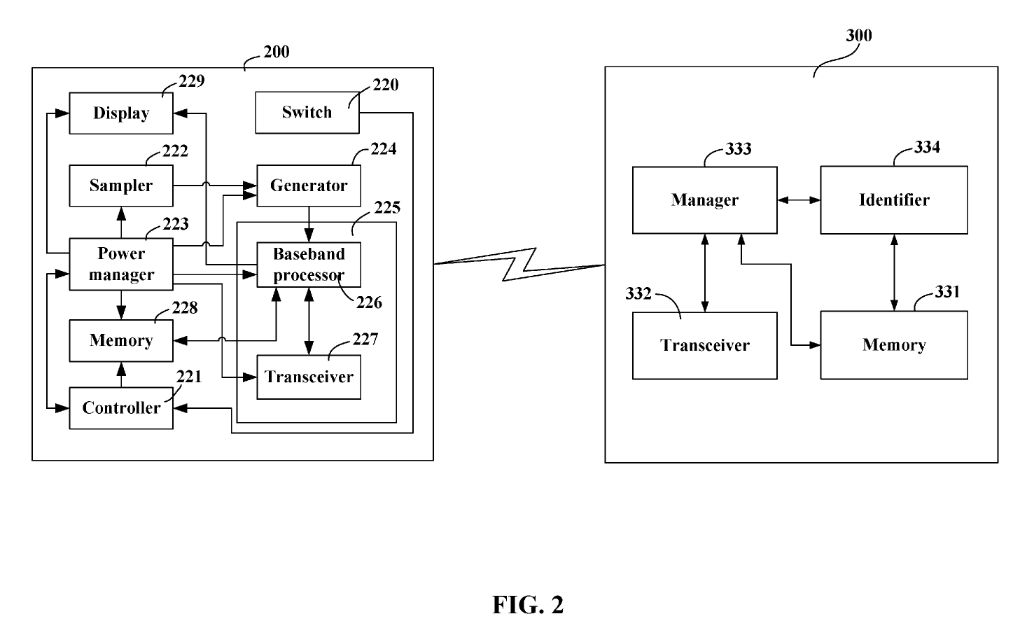

Referring to FIG. 2, the mobile communication device 200 includes a switch 220, a controller 221, a sampler 222, a power manager 223, a generator 224, a communication module 225, a memory 228, and a display 229. The communication module 225 includes a baseband processor 226 and a transceiver 227. Before the mobile communication device 200 is distributed into the market, a unique international mobile equipment identity (IMEI) number is assigned to the mobile communication device 200.

The switch 220 is used for powering on or powering off the mobile communication device 200. The power manager 223 is used for supplying power to other components of the mobile communication device 200. The sampler 222 is used for sampling a subscriber's biometric information, such as iris information, fingerprint information, voice information, etc. The sampler 222 can be a camera, a fingerprint scanner, or a microphone. In this embodiment, the biometric information correlates to iris information, and the sampler 222 is a camera. The sampler 222 is used for capturing an iris image of the subscriber, and sending the iris image to the generator 224.

The generator 224 is used for analyzing the iris image to extract iris identity data, generating an iris analysis according to the iris identity data, and sending the iris analysis to the baseband processor 226. The baseband processor 226 is used for processing the iris analysis and the IMEI number to generate digital signals according to various communication standards, such as global system for mobile communication (GSM) standard, code division multiple access (CDMA) standard, and time division multiple access (TDMA) standard, etc.

The transceiver 227 is used for receiving the digital signals and generating radio frequency (RF) signals, transmitting the RF signals to the base station 300 to request a phone number, and receiving the phone number. The memory 228 is used for storing the phone number after the phone number is received from the base station 300 and the IMEI number.

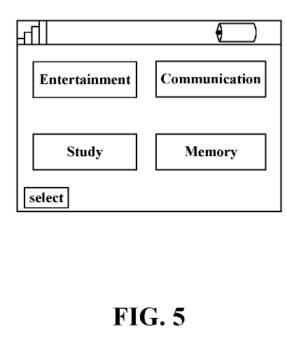

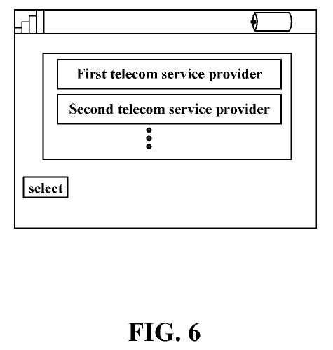

The display 229 is used for displaying information of the mobile communication system 100 to the subscriber. Referring to FIG. 5, the display 229 has a graphical user interface (GUI) including an entertainment icon, a communication icon, a study icon, a memory icon, and a select button. If the select button is pressed, referring to FIG. 6, a telecom service provider selection menu is opened. The telecom service provider selection menu includes various service provider icons, such as a first telecom service provider and a second telecom service provider.

The base station 300 includes a memory 331, a transceiver 332, a manager 333, and an identifier 334. The memory 331 is used for storing the phone number and an iris profile of each subscriber stored when the subscriber signed up for an account with the telecom service providers. The transceiver 332 is used for receiving the RF signals, and transforming the RF signals to the digital signals, and transmitting the phone number to the mobile communication device 200. The manager 333 is used for receiving the digital signals, and processing the digital signals to retrieve the iris analysis and the IMEI number.

The identifier 334 is used for comparing the iris analysis and the user iris profile. If the iris analysis and the user iris profile are the same, the identifier 334 signals the manager 333 to select the phone number, to generate a login result “0”, and the transceiver 332 sends the phone number and the login result “0” to the mobile communication device 200. The communication device 200 receives the phone number and the login result “0”, and stores the phone number and displays information to inform subscribers that they can use the communication device 200 to communicate with others according to the login result “0”. If the iris analysis is different from the user iris profile, the identifier 334 generates a login result “1”, and the transceiver 332 sends the login result “1” to the mobile communication device 200. The communication device 200 receives the login result “1” and displays information to inform subscribers that the biometric information does not match and they need to sign up to a new account.

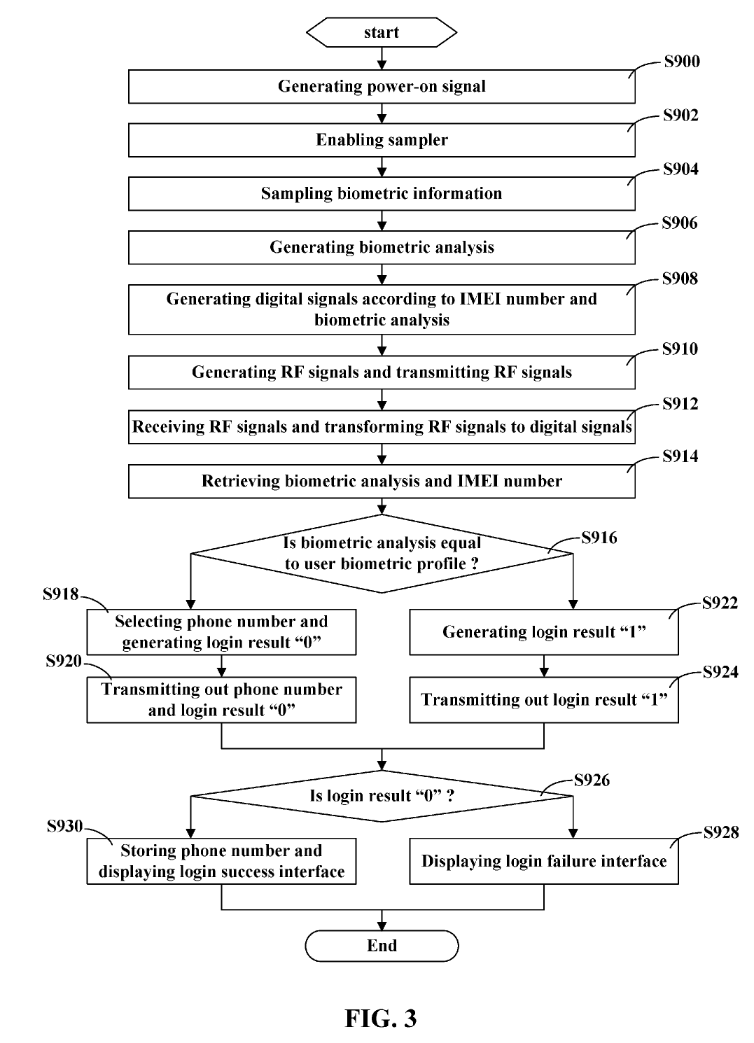

Referring to FIG. 3, a mobile communication method in accordance with an exemplary embodiment is for identifying subscribers using the mobile communication system 100. A procedure of the mobile communication method includes the following steps.

Step S900, the mobile communication device 200 is powered on by the switch 220. The switch 220 is pressed by subscribers, and generates a power-on signal to the controller 221.

Step S902, the controller 221 receives the power-on signal, and signals the power manager 223 to enable the sampler 222.

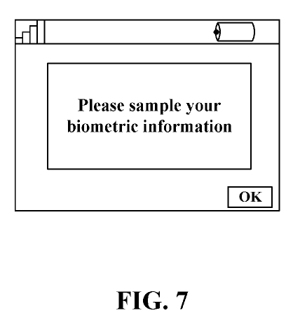

Step S904, the sampler 222 performs a sampling operation that the sampler 222 samples a subscriber's biometric information. In this step, the display 229 displays a sample interface to the subscriber. Referring to FIG. 7, the sample interface shows an indication sentence “Please sample your biometric information” and an OK button. If the OK button is clicked, the sampling operation is performed.

Step S906, the generator 224 analyzes the biometric information to extract biometric data and generates a biometric analysis.

Step S908, the baseband processor 226 processes the biometric analysis and an IMEI number of the mobile communication device 200 to generate digital signals.

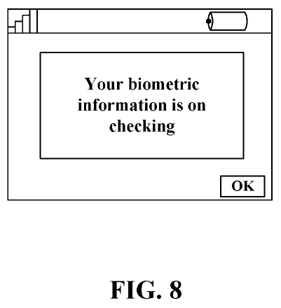

Step S910, the transceiver 227 generates RF signals according to the digital signals, and transmits the RF signals to the base station 300 to request a phone number. In this step, the display 229 displays a waiting interface to the subscriber. Referring to FIG. 8, the waiting interface shows an indication sentence “Your biometric information is on checking”

Step S912, the transceiver 332 receives the RF signals, and transforms the RF signals to the digital signals.

Step S914, the manager 333 retrieves the biometric analysis and the IMEI number from the digital signals.

Step S916, the identifier 334 compares the biometric analysis and a user biometric profile stored in the memory 331.

Step S918, the manager 333 selects a phone number stored in the memory 331 corresponding to the biometric analysis, and generates a login result “0” if the biometric analysis and the user biometric profile are the same.

Step S920, the transceiver 332 sends the phone number and the login result “0” to the mobile communication device 200 based on the IMEI number.

Step S922, the manager 333 generates a login result “1” if the biometric analysis is different from the user biometric profile.

Step S924, the transceiver 332 sends the login result “1” to the mobile communication device 200 based on the IMEI number.

Step S926, the baseband processor 226 identifies the login result.

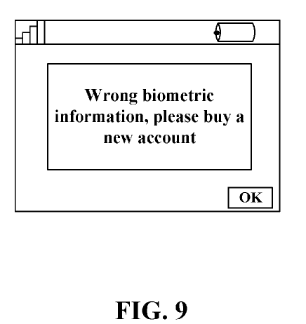

Step S928, the display 229 displays a login failure interface to the subscriber if the login result is “1”. In this step, referring to FIG. 9, the login failure interface shows an indication sentence “Wrong biometric information, please buy a new account.”

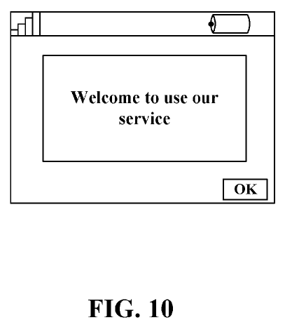

Step S930, the memory 228 stores the phone number and the display 229 displays a login success interface if the login result is “0”. In this step, referring to FIG. 10, the login success interface shows an indication sentence “Welcome to use our service.”

As mentioned above, except for SIM cards and PIN numbers, subscribers' biometric information is used in identifying the subscribers before using their accounts.

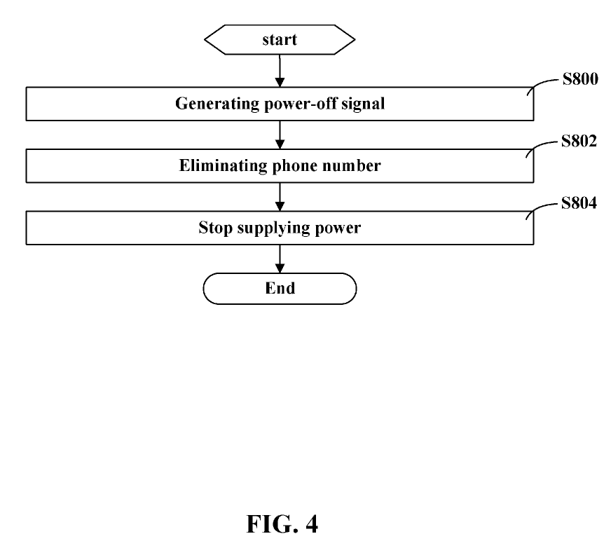

Besides, referring to FIG. 4, a method for deleting the phone number from the memory 228 includes the following steps.

Step 800, the mobile communication device 200 is powered off. The switch 220 is pressed by subscribers, and generates a power-off signal to the controller 221.

Step 802, the controller 221 receives the power-off signal, and deletes the phone number from the memory 228.

Step 804, the controller 221 signals power manager 223 to stop supplying power to the mobile communication device 200.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile communication method for identifying a subscriber of a mobile communication device, the mobile communication method comprising:
sampling biometric information of the subscriber;
generating a biometric analysis;
generating digital signals according to the biometric analysis and an IMEI number;
generating RF signals according to the digital signals and transmitting the RF signals;
receiving the RF signals and transforming the RF signals to the digital signals;
retrieving the biometric analysis and the IMEI number from the digital signals;
comparing the biometric analysis and a user biometric profile;
selecting a phone number according to the biometric analysis if the biometric analysis and the user biometric profile are the same; and
transmitting the phone number to the mobile communication device based on the IMEI number.

2. The mobile communication method according to claim 1, further comprising:
powering the mobile communication device.

3. The mobile communication method according to claim 1, further comprising:
generating a login result “0” if the biometric analysis and the user biometric profile are the same;
transmitting the login result “0” to the mobile communication device based on the IMEI number.

4. The mobile communication method according to claim 3, further comprising:
storing the phone number;
displaying a login success interface.

5. The mobile communication method according to claim 1, further comprising:
generating a login result “1” if the biometric analysis is different from the user biometric profile;
transmitting the login result “1” to the mobile communication device based on the IMEI number.

6. The mobile communication method according to claim 5, further comprising:
displaying a login failure interface.

7. A mobile communication device having a IMEI number, the mobile communication device comprising:
a sampler for sampling biometric information;
a generator for analyzing the biometric information to extract biometric identity data and generating a biometric analysis according to the biometric identity data;
a baseband processor for processing the iris analysis and IMEI number to generate digital signals; and
a transceiver for receiving the digital signals and generating RF signals and transmitting the RF signals.

8. The mobile communication device according to claim 7, further comprising a switch for powering on or powering off the mobile communication device.

9. The mobile communication device according to claim 7, further comprising a power manager for supplying power.

10. A mobile communication system comprising:
a mobile communication device having a IMEI number, the mobile communication device for sampling biometric information of a subscriber, extracting biometric analysis from the biometric information, generating RF signals according to the IMEI number and the biometric analysis, and transmitting the RF signals; and
a base station for receiving the RF signals, the base station comprising:
a manager for retrieving the IMEI number and the biometric information according to the RF signals;
an identifier for comparing the biometric analysis with a user biometric profile stored in the base station; and
a transceiver for transmitting a phone number corresponding to the biometric analysis to the mobile communication device based on the IMEI number if the biometric analysis and the user biometric profile are the same.

11. The mobile communication system according to claim 10, wherein the base station comprises a memory for storing the phone number and the user biometric profile.

12. The mobile communication system according to claim 10, wherein the transceiver is used for receiving the RF signals, and transforming the RF signals to digital signals.

13. The mobile communication system according to claim 10, wherein the manager is used for generating a login result “0” and the transceiver is used for transmitting the login result “0” to the mobile communication device if the biometric analysis and the user biometric profile are the same.

14. The mobile communication system according to claim 13, wherein the mobile communication device is for receiving the login result “0” and the phone number, and storing the phone number and displaying a login success interface.

15. The mobile communication system according to claim 10, wherein the manager is used for generating a login result “1” and the transceiver is used for transmitting the login result “1” to the mobile communication device if the biometric analysis is different from the user biometric profile.

16. The mobile communication system according to claim 15, wherein the mobile communication device is for receiving the login result “1” and displaying a login failure interface.
